(19) United States
(12) Patent Application Publication
(10) Pub. No.: US 2024/0333580 A1
(43) Pub. Date: Oct. 3, 2024

(54) METHOD AND SYSTEM FOR FAST FAILOVER IN ISP PEERING

(71) Applicant: HEWLETT PACKARD ENTERPRISE DEVELOPMENT LP, Spring, TX (US)

(72) Inventors: Anoop Govindan Nair, Bangalore (IN); Venkatesh Natarajan, Bangalore (IN); Vincent Giles, Grenoble (FR); Saurabh Mohan, Roseville, CA (US); Nisarg Shah, Folsom, CA (US)

(21) Appl. No.: 18/329,689

(22) Filed: Jun. 6, 2023

(30) Foreign Application Priority Data
Mar. 28, 2023 (EP) EP23305424.6

(51) Int. Cl. H04L 41/0654

(52) U.S. Cl. CPC H04L 41/0654

(57) ABSTRACT

Methods and systems configured for fast failover in ISP peering are disclosed herein. One method comprises: establishing a fault detection protocol session between a first router and a second router, the first and second routers being computing network peers; the first router responding to a data communication connection between the first router and a first provider edge router going down by altering a status of the fault detection protocol session to a changed status; and the second router responding to the changed status of the fault detection protocol session by rerouting traffic served by the first provider edge router to a second provider edge router.

### DESCRIPTION OF RELATED ART

An existing topology for ISP peering between Customer Edge (CE) routers and internet service provider (ISP) Provider Edge (PE) routers is illustrated schematically in FIG. 1A. Topology 100 includes first core router (CR₁) 102 and second core router (CR₂) 104 (being important customer routers), each in communication with border routers in the form of a first customer edge router (CE₁) 106 and a second customer edge router (CR₂) 108, such as via a LAN. The connections between these devices are represented by links 110, 112 from first core router 102 to first and second customer edge routers 108, 110, respectively, and by links 114, 116 from second core router 104 to first and second customer edge routers 108, 110, respectively.

First and second customer edge routers 108, 110 are connected to respective first and second ISP provider edge routers 118, 120, via respective eBGP links 122, 124 (i.e. Exterior Border Gateway Protocol connections). An iBGP (Interior Border Gateway Protocol) link 126 connects first and second customer edge routers 106, 108. Between the first and second core routers 102, 104 there is also a static default route 128 (comprising Embedded MultiChip Packages) pointing to each other with higher Administrative Distance. Default route 128 helps when eBGP link 122 from first customer edge router 106 to first provider edge router 118 goes down; likewise, default route 128 helps when eBGP link 124 from second customer edge router 108 to second provider edge router 120 goes down.

Both first and second customer edge routers 106, 108 may run BGP-PIC (Border Gateway Protocol-Prefix Independent Convergence), which can implement a BGP fast failover mechanism and recalculate the best path after a link becomes bad. This means that alternate paths will be available for fast failover switch when the preferred next hop goes down. When the network and links are in a steady state: first customer edge router 106 will have prefixes for P1 pointing to first provider edge router 118 with a backup alternate path for P1 pointing to second customer edge router 108, while second customer edge router 108 will have prefixes for P1 pointing to first customer edge router 106 with a backup alternate path for P1 pointing to second provider edge router 120; second customer edge router 108 will have prefixes for P2 pointing to second provider edge router 120 with a backup alternate path for P2 pointing to first customer edge router 106, while first customer edge router 106 will have prefixes for P2 pointing to second customer edge router 108 with a backup alternate path for P2 pointing to first provider edge router 118.

Hence, in the event that eBGP link 124 between second customer edge router 108 and second provider edge router 120 goes down, traffic for P2 prefixes in second customer edge router 108 redirect from second provider edge router 120 (i.e. its primary path) to first customer edge router 106 (its secondary path). That is, traffic arriving at second customer edge router 108 for P2 is switched to first customer edge router 106 instead of second provider edge router 120, in response to second customer edge router 108 detecting that eBGP link 124 has gone down.

However, at the scale of large internet routes, the BGP process on second customer edge router 108-for example-will take time to withdraw the P2 prefixes (i.e. Prefix-2 set of routes), and first customer edge router 106 will continue to route traffic 132/134 destined to the Prefix-2 set of routes to second customer edge router 108 for the period in which first customer edge router 106 does not converge for Prefix-2. As a consequence, the traffic will not switch over promptly even if BGP-PIC or BGP FRR (Border Gateway Protocol Free Range Routing (tm)) alternate paths are available for a fast failover switch in the forwarding information base (FIB).

This problem is exacerbated by the fact that, typically, provider edge routers (such as provider edge routers 118, 120) do not permit running BFD or ICMP pings to them for security reasons.

FIG. 1B depicts another existing topology 150 for ISP peering. Topology 150 is similar to topology 100 of FIG. 1A but additionally includes, for redundancy, a link 152 (which supports eBGP) between first customer edge router 106 and second provider edge router 120, and a link 154 (which also supports eBGP) between second customer edge router 108 and first provider edge router 118. Default route 128 then helps when both of links 122, 152 from first customer edge router 106 to first and second provider edge routers 118, 120, respectively, go down; likewise, default route 128 helps when both of links 124, 154 from second customer edge router 108 to first and second provider edge routers 118, 120, respectively, go down.

However, while this redundancy may be advantageous, such additional links (e.g. links 152, 154) to ISP provider edge routers also increase cost.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A is a schematic illustration of an existing topology for ISP peering between customer edge routers and ISP provider edge routers;

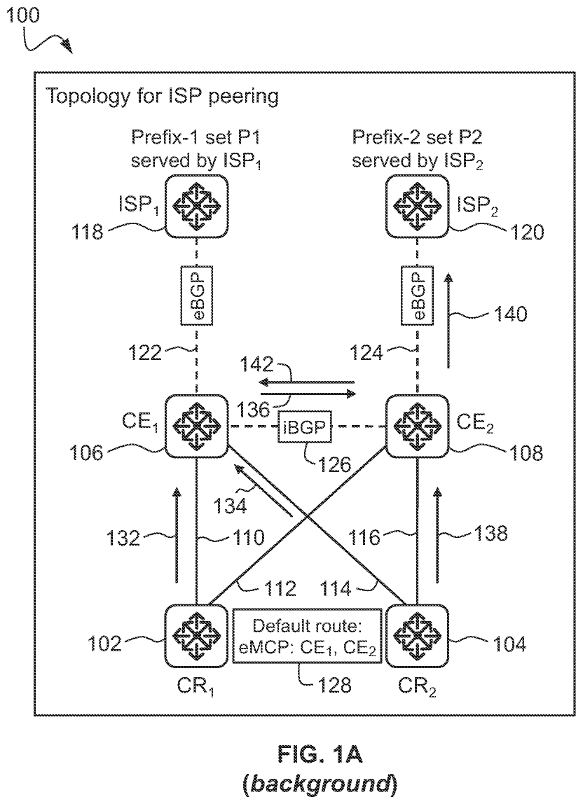

FIG. 1B is a schematic illustration of another existing topology for ISP peering between customer edge routers and ISP provider edge routers;

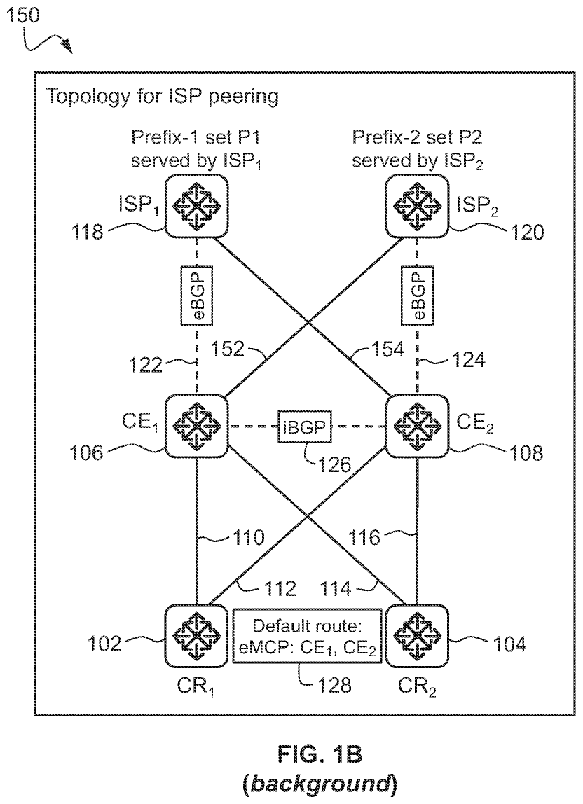

FIG. 2 is a conceptual diagram of a system with ISP peering, according to some embodiments;

FIG. 3A is a conceptual diagram of the first customer edge router of the system of FIG. 2, according to some embodiments;

FIG. 3B is a conceptual diagram of the second customer edge router of the system of FIG. 2, according to some embodiments;

FIG. 4 is a follow diagram of the operation of the system of FIG. 2, according to some embodiments.

The figures are not exhaustive and do not limit the present disclosure to the precise form disclosed.

### DETAILED DESCRIPTION

Various embodiments described herein are directed to methods and systems for fast failover in ISP peering.

The present invention provides a computer-implemented method comprising:
establishing a fault detection protocol session between a first router and a second router (which may be customer edge routers or border routers), the first and second routers being computing network peers;
the first router responding to a data communication connection between the first router and a first provider edge router (such as of an ISP) going down by altering a status of the fault detection protocol session to a changed status; and
the second router responding to the changed status of the fault detection protocol session by rerouting traffic served by the first provider edge router to a second provider edge router.

Advantageously, therefore, the second router is essentially immediately alerted to the first data communication connection becoming bad or going down, so that fast failover for the first set of prefixes to the alternate path can be triggered, again, essentially immediately.

The fault detection protocol is advantageously a bidirectional forwarding detection protocol. The bidirectional forwarding detection protocol provides low-overhead fault detection. However, it will be appreciated that the status can be conveyed via any proprietary protocol configured to respond to the data communication connection going down by changing its status, and consequently constitute a fault detection protocol.

It will be appreciated that the first and second routers may have one or more additional network peers.

The method may comprise monitoring whether the data communication connection has gone down with one or more sensors (such as of the first router), such as by monitoring a routing protocol session (such as a Border Gateway Protocol session) between the first router and the first provider edge router, by performing nexthop tracking, and/or by tracking when connectivity between the first router and the first provider edge router is down by examining ARP (Address Resolution Protocol) Tables of the first router and determining whether a Host/ARP entry of the first provider edge router is missing from the router.

The first router advantageously comprises the one or more sensors, so that any delay between the detection of the first data communication connection going down and the first router's response thereto is minimized.

The changed status of the fault detection protocol session may be down or indicate that the fault detection protocol session is down.

The method may comprise the first router responding to the one or more sensors detecting that the fault detection protocol session has the changed status by rerouting traffic served by the second provider edge router to the first provider edge router.

The present invention also provides a system comprising:
a first router and a second router, the first and second routers (which may be customer edge routers or border routers) being peers in a computing network;
a first data communication connection for providing data communication between the first router and a first provider edge router; and
a second data communication connection for providing data communication between the second router and a second provider edge router;
wherein the first router is configured to respond to the first data communication connection going down by changing a status of a fault detection protocol session between the first router and the second router to a changed status; and
the second router is configured to respond to the changed status of the fault detection protocol session by rerouting traffic served by the first provider edge router to a second provider edge router.

The fault detection protocol is advantageously a bidirectional forwarding detection protocol.

The system may comprise one or more sensors (such as of the first router) configured to monitor whether the first data communication connection has gone down, such as by monitoring a routing protocol session or connection (such as a Border Gateway Protocol session) between the first router and the first provider edge router, by performing nexthop tracking, and/or by tracking when connectivity between the first router and the first provider edge router is down by examining ARP (Address Resolution Protocol) Tables of the first router and determining whether a Host/ARP entry of the first provider edge router is missing from the router.

The changed status of the fault detection protocol session may be down or indicate that the fault detection protocol session is down.

The first router may be additionally configured to respond to the first data communication connection going down by rerouting traffic served by the first provider edge router to the second router or to the second provider edge router.

The invention also provides a router comprising:
one or more sensors configured to detect whether a data communication connection between the router and a first provider edge has gone down;
wherein the router is configured to respond to the one or more sensors detecting that the data communication connection has gone down by changing a status of a fault detection protocol session between the router and a peer router to a changed status and thereby notify the peer router that the data communication connection has gone down; and
the router is further configured to respond to detecting that the fault detection protocol session has the changed status by rerouting traffic served by a second provider edge router in data communication with the peer router to the first provider edge router.

The one or more sensors may be configured to monitor a routing protocol session or connection (such as a BGP session) between the first router and the first provider edge router in order to detect whether the data communication connection has gone down, to perform nexthop tracking, and/or to track when connectivity between the first router and the first provider edge router is down by examining ARP (Address Resolution Protocol) Tables of the router and determine whether a Host/ARP entry of the first provider edge router is missing from the router.

Other embodiments of the invention provide computer program code that when executed by one or more processors causes the one or more processors to implement any of the respective embodiments of the method of the invention. The one or more processors may be provided in one or more routers of embodiments of the invention.

In other embodiments, there is provided a computer readable medium (which may be non-transitory) comprising any of the respective embodiments of the computer program code. The computer readable medium may be provided in one or more routers of embodiments of the invention.

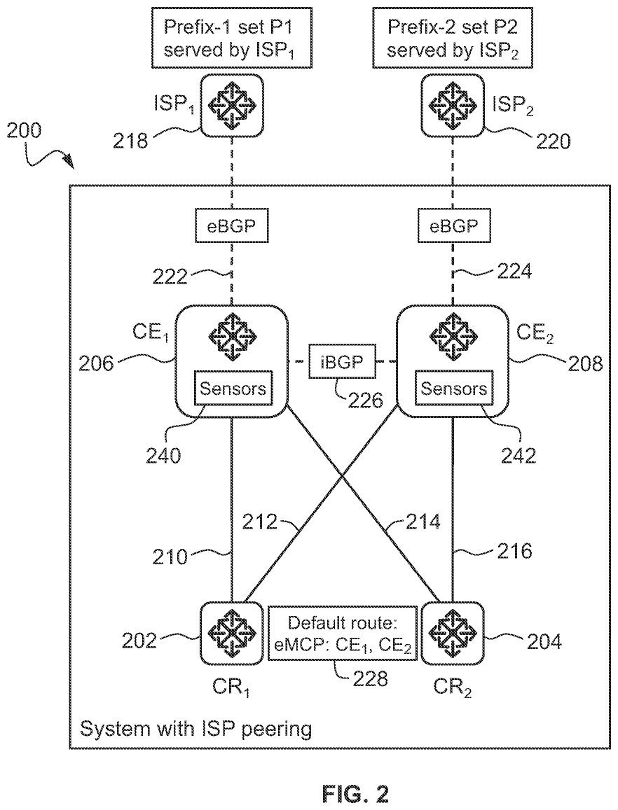

FIG. 2 is a conceptual diagram of a system 200 with ISP peering according to some embodiments, shown with ISP provider edge routers. Referring to FIG. 2, system 200 includes first and second core routers 202, 204 and first and second customer edge routers (CE₁, CE₂) 206, 208, which are peers. System 200 includes two links 210, 212 to provide communication between first core router 202 and first and second customer edge routers 206, 208, respectively, and two links 214, 216 to provide communication between second core router 204 and first and second customer edge routers 206, 208, respectively. Links 210, 212, 214, 216 may be provided in any suitable form, such as in the form of a LAN.

System 200 also includes two communication links or connections 222, 224 connected to first and second customer edge routers 206, 208, respectively, for external communication and configured to support communication with first and second ISP provider edge routers 218, 220, respectively. Communication links 222, 224 are implemented according to routing protocols, in this example eBGP.

System 200 also includes a communication link or connection 226 implemented according to a routing protocol (e.g. iBGP) between first and second customer edge routers 206, 208.

System 200 further includes a static default route 228 (comprising Embedded MultiChip Packages) between first and second core routers 202, 204, which point to each other with higher Administrative Distance. Default route 228 helps when eBGP link 222 from first customer edge router 206 to first provider edge router 218 goes down and helps when eBGP link 224 from second customer edge router 208 to second provider edge router 220 goes down.

First and second customer edge routers 206, 208 include first and second sets of one or more sensors 240, 242, respectively. First set of sensors 240 is configured to sense the health of link 222 between first customer edge router 206 and first provider edge router 218 by monitoring the routing protocol session (in this example an eBGP session) on that link. Likewise, second set of sensors 242 is configured to sense the health of link 224 by monitoring the routing protocol session (in this example an eBGP session) between second customer edge router 206 and second provider edge router 220.

The output of each set of sensors 240, 242 provides input for a fault detection protocol session, in this example a BFD session, established by system 200 between first and second customer edge router 206, 208. This fault detection protocol session is established in order to communicate particular detection events from first customer edge router 206 to second customer edge router 208 or vice versa, as described below. BRD operating in asynchronous mode (in which BFD control packets sent by first customer edge router 206 to second customer edge router 208 and vice versa) is employed in this example as it provides low-overhead fault detection.

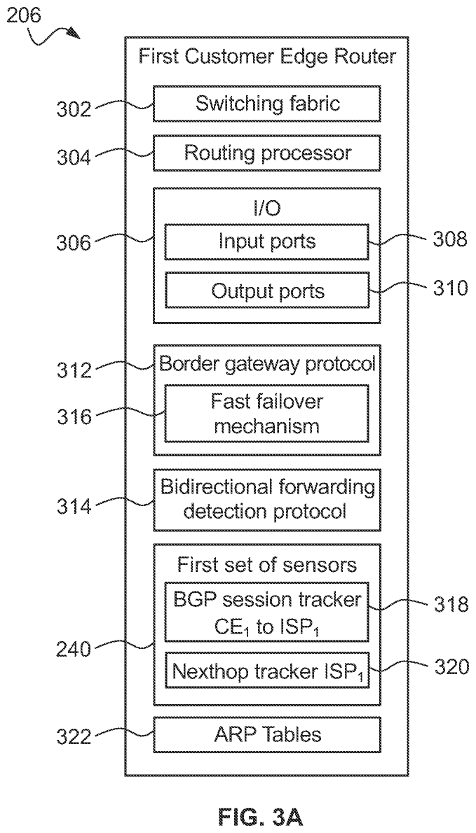

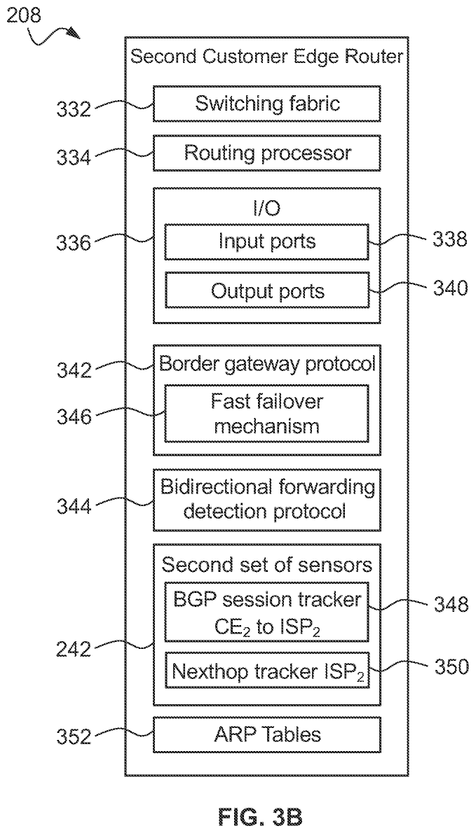

FIGS. 3A and 3B are conceptual diagrams of first and second customer edge routers 206, 208, respectively, illustrating certain components pertinent to this disclosure. It may be noted that first and second customer edge routers 206, 208 have identical architectures in this example. Referring to FIG. 3A, first customer edge router 206 includes first set of one or more sensors 240, a switching fabric 302, a routing processor 304, an input output interface (I/O) interface 306 (including input ports 308 and output ports 310) for communicating with other routers (202, 204, 208, 218), a border gateway protocol 312 and a bidirectional forwarding detection protocol 314. Border gateway protocol 312 exchanges routing and reachability information with second customer edge router 208 and first provider edge router 218, and includes a fast failover mechanism 316, in this example BGP-PIC or BGP FRR. Bidirectional forwarding detection protocol 314 is configured to establish a special BFD session between first customer edge router 206 and second customer edge router 208.

First set of sensors 240 includes both a routing protocol session tracker in the form of Border Gateway Protocol session tracker 318, and a nexthop tracker 320. First set of sensors 240 may be implemented as hardware, firmware, or software (i.e. as computer program code) and—in the last example—executed by routing processor 304. BGP session tracker 318 is configured to track or sense the health of the (e.g. BGP) session or connection between first customer edge router 206 and first provider edge router 218. When BGP session tracker 318 detects that the connection between first customer edge router 206 and first provider edge router 218 has gone down, first customer edge router 206 responds by signalling second customer edge router 208 using the BFD session between first and second customer edge routers 206, 208, in this example by changing the status of the BFD session to ‘down’.

Nexthop tracker 320 provides the same function, but by tracking Nexthop health. It does so by examining the ARP (Address Resolution Protocol) Tables 322 of first customer edge router 206, performing event-based validation of Host/ARP entries in ARP Tables 322 (monitoring in particular for a persistent unavailability of next-hop resolution of first provider edge router 218), and updating ARP Tables 322 accordingly. If an ARP entry for first provider edge router 218 is momentarily absent from ARP Tables 322, first customer edge router 206 does not immediately signal second customer edge router 208, as that ARP entry may be missing for only a brief period. However, if that ARP entry absence persists (for a user selectable or tunable period, e.g. a few seconds), first customer edge router 206 signals second customer edge router 208 using the BFD session between first and second customer edge routers 206, 208, in this example by changing the status of the BFD session to ‘down’.

Hence, BGP session tracker 318 and a nexthop tracker 320 each serve as a sensor configured to detect that the connection between first customer edge router 206 and first provider edge router 218 has gone down. First set of sensors 240 may therefore include either or both of them, and in some examples, BGP session tracker 318 implements nexthop tracker 320.

Referring to FIG. 3B, second customer edge router 208, being identical in architecture with first customer edge router 206, includes second set of sensors 242, a switching fabric 332, a routing processor 334, an input output interface (I/O) interface 336 (including input ports 338 and output ports 340) for communicating with other routers (202, 204, 206, 220), a border gateway protocol 342, a bidirectional forwarding detection protocol 344 and fast failover mechanism 346. Border gateway protocol 342 exchanges routing and reachability information with first customer edge router 206 and second provider edge router 220, and includes a fast failover mechanism 346, in this example BGP-PIC or BGP FRR. Bidirectional forwarding detection protocol 344 is configured to establish a special BFD session between first customer edge router 206 and second customer edge router 208.

Second set of sensors 242 includes both a routing protocol session tracker in the form of Border Gateway Protocol session tracker 348, and a nexthop tracker 350. Second set of sensors 242 may be implemented as hardware, firmware, or software (i.e. as computer program code) and—in the last example—executed by routing processor 304. BGP session tracker 348 is configured to track or sense the health of the (e.g. BGP) session or connection between second customer edge router 208 and second provider edge router 220. When BGP session tracker 348 detects that the connection between second customer edge router 208 and second provider edge router 220 has gone down, second customer edge router 208 responds by signalling first customer edge router 206 using the BFD session between first and second customer edge routers 206, 208, in this example by changing the status of the BFD session to ‘down’.

Nexthop tracker 350 provides the same function, but by tracking Nexthop health. It does so by examining ARP Tables 352 of second customer edge router 208, performing event-based validation of routes in ARP Tables 352 (monitoring in particular for the persistent unavailability of next-hop resolution of second provider edge router 220), and updating ARP Tables 352 accordingly. If an ARP entry for second provider edge router 220 is momentarily absent from ARP Tables 352, second customer edge router 208 does not immediately signal first customer edge router 206, as that ARP entry may be missing for only a brief period. However, if that ARP entry absence persists (for a user selectable or tunable period, e.g. a few seconds), second customer edge router 208 signals first customer edge router 206 using the BFD session initiated by bidirectional forwarding detection protocol 344 between first and second customer edge routers 206, 208, in this example by changing the status of the BFD session to ‘down’.

Hence, BGP session tracker 348 and a nexthop tracker 350 each serve as a sensor configured to detect that the connection between second customer edge router 208 and second provider edge router 220 has gone down. Second set of sensors 242 may therefore include either or both of them, and in some examples, BGP session tracker 348 implements nexthop tracker 350.

Thus, fast failover mechanism 316 of first customer edge router 206 is configured to perform fast failover in response to being alerted that the health of the connection between second customer edge router 208 and second provider edge router 220 is bad (such as when the BGP connection between second customer edge router 208 and second provider edge router 220 has gone down). Specifically, BGP session tracker 348 of second customer edge router 208 is configured to respond to detecting that the connection between second customer edge router 208 and second provider edge router 220 is bad by communicating that detection (such as in the form of an alert) to fast failover mechanism 346 of second customer edge router 208 and to bidirectional forwarding detection protocol 344 of second customer edge router 208. Fast failover mechanism 346 of second customer edge router 208 responds by triggering fast failover switch for prefixes for P2 to alternate nexthop, first customer edge router 206.

Bidirectional forwarding detection protocol 344 is configured to respond by changing the status of the special BFD session between first and second customer edge routers 206, 208, in this example to ‘down’; this is in turn detected by bidirectional forwarding detection protocol 314 of first customer edge router 206, thereby notifying first customer edge router 206 that the connection between second customer edge router 208 and second provider edge router 220 is bad or down. BGP session tracker 318 of first customer edge router 206 is configured to communicate this status to fast failover mechanism 316 of first customer edge router 206.

Fast failover mechanism 316 of first customer edge router 206 implements BGP-PIC or BGP FRR so is ready with alternate routes. For prefix-1 set P1 (normally served by ISP₁), first customer edge router 206 has prefixes for P1 pointing to first provider edge router 218, with back up alternate path for P1 pointing to second customer edge router 208. For prefix-2 set P2 (normally served by ISP₂), first customer edge router 206 has prefixes for P2 pointing to second customer edge router 208, with back up alternate path for P2 pointing to first provider edge router 218. Fast failover mechanism 316 of first customer edge router 206 thus responds to being alerted to the ‘bad’ status of the connection between second customer edge router 208 and second provider edge router 220 by triggering a fast failover for prefixes for P2 to the alternate nexthop, first provider edge router 218.

Fast failover mechanism 346 of second customer edge router 208 is configured similarly and performs fast failover in response to being alerted that the health of the connection between first customer edge router 206 and first provider edge router 218 (such as when the BGP connection between first customer edge router 206 and first provider edge router 218 has gone down). Specifically, BGP session tracker 318 of first customer edge router 206 is configured to respond to detecting that the connection between first customer edge router 206 and first provider edge router 218 is bad by communicating that detection to fast failover mechanism 316 of first customer edge router 206 and to bidirectional forwarding detection protocol 314 of first customer edge router 206. Fast failover mechanism 316 of first customer edge router 206 responds by triggering fast failover switch for prefixes for P1 to alternate nexthop, second customer edge router 208.

Bidirectional forwarding detection protocol 314 is configured to respond by changing the status of the special BFD session between first and second customer edge routers 206, 208, in this example to ‘down’; this is in turn detected by bidirectional forwarding detection protocol 344 of second customer edge router 208, thereby notifying second customer edge router 208 that the connection between first customer edge router 206 and first provider edge router 218 is bad. BGP session tracker 348 of second customer edge router 208 is configured to communicate this status to fast failover mechanism 346 of second customer edge router 208.

Fast failover mechanism 346 of second customer edge router 208 also implements BGP-PIC or BGP FRR so is similarly ready with alternate routes. For prefix-2 set P2 (normally served by ISP₂), second customer edge router 208 has prefixes for P2 pointing to second provider edge router 220, with back up alternate path for P2 pointing to first customer edge router 206. For prefix-1 set P1 (normally served by ISP₁), second customer edge router 208 has prefixes for P1 pointing to first customer edge router 206, with back up alternate path for P1 pointing to second provider edge router 220. Fast failover mechanism 346 of second customer edge router 208 thus responds to being alerted to the ‘bad’ status of the connection between first customer edge router 206 and first provider edge router 218 by triggering a fast failover for prefixes for P1 to the alternate nexthop, second provider edge router 220.

It will be noted that each of bidirectional forwarding detection protocol 314 of first customer edge router 206 and bidirectional forwarding detection protocol 344 of second customer edge router 208 can establish the special BFD session between first and second customer edge routers 206, 208. In use, only one of bidirectional forwarding detection protocols 314, 344 need do so; once that BFD session has been established by one, the other will detect that BFD session and refrain from attempting to establish another.

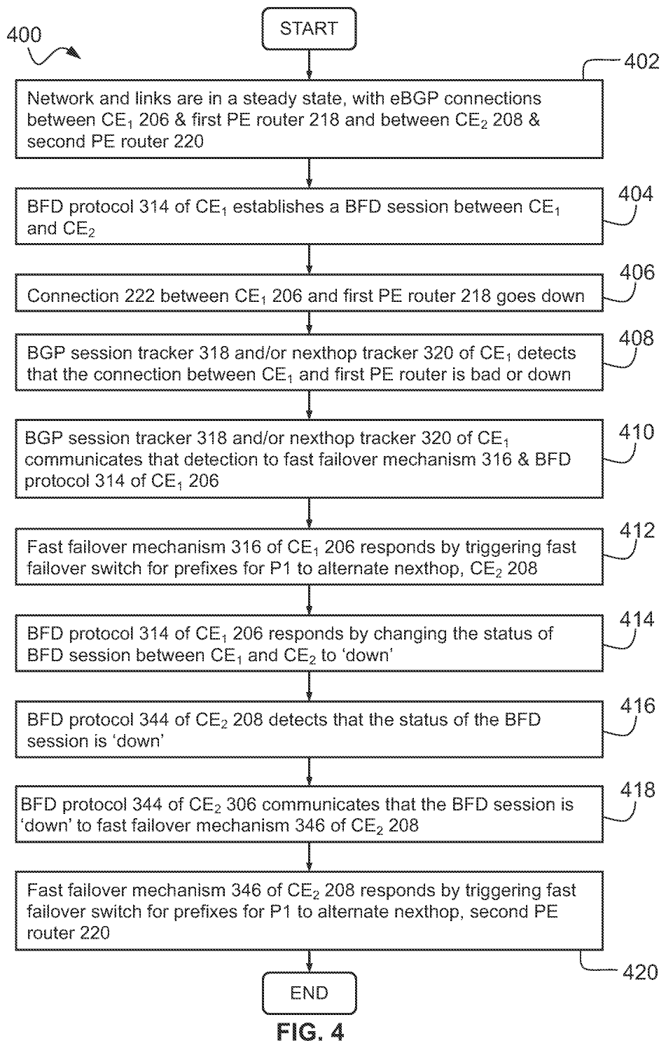

FIG. 4 is a follow diagram 400 of the operation of system 200 of FIG. 2, according to some embodiments, from the perspective of first customer edge router 206. Referring to FIG. 4, at step 402 the network and links are in a steady state, with an eBGP connection 222 between first customer edge router 206 and first provider edge router 218 and an eBGP connection 224 between second customer edge router 208 and second provider edge router 220. For prefix P1, first customer edge router 206 has prefixes for P1 pointing to first provider edge router 218 with a backup alternate path for P1 pointing to second customer edge router 208; second customer edge router 208 has prefixes for P1 pointing to first customer edge router 206 with a backup alternate path for P1 pointing to second provider edge router 220. For prefix P2, second customer edge router 208 will have prefixes for P2 pointing to second provider edge router 220 with a backup alternate path for P2 pointing to first customer edge router 206, while first customer edge router 206 has prefixes for P2 pointing to second customer edge router 208 with a backup alternate path for P2 pointing to first provider edge router 218.

At step 404, bidirectional forwarding detection protocol 314 of first customer edge router 206 establishes a BFD session between first customer edge router 206 and second customer edge router 208.

At step 406, the connection between first customer edge router 206 and first provider edge router 218 goes down. At step 408, BGP session tracker 318 and/or nexthop tracker 320 of first customer edge router 206 detects that the connection between first customer edge router 206 and first provider edge router 218 is down.

At step 410, BGP session tracker 318 and/or nexthop tracker 320 of first customer edge router 206 communicates that detection to fast failover mechanism 316 and bidirectional forwarding detection protocol 314 of first customer edge router 206.

At step 412, fast failover mechanism 316 of first customer edge router 206 responds by triggering fast failover switch for prefixes for P1 to alternate nexthop, second customer edge router 208.

At step 414, bidirectional forwarding detection protocol 314 responds by changing the status of the special BFD session between first and second customer edge routers 206, 208 to ‘down’.

At step 416, bidirectional forwarding detection protocol 344 of second customer edge router 208 detects that the status of the special BFD session is ‘down’, such that the health of the connection between first customer edge router 206 and first provider edge router 218 is propagated to second customer edge router 208 for action.

At step 418, bidirectional forwarding detection protocol 344 of second customer edge router 208 communicates that the special BFD session is ‘down’ to fast failover mechanism 346 of second customer edge router 208 and, at step 420, fast failover mechanism 346 of second customer edge router 208 responds by triggering fast failover switch to alternate nexthop, second provider edge router 220.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A computer-implemented method comprising:
establishing a fault detection protocol session between a first router and a second router, the first and second routers being computing network peers;
detecting, by the second router, a down status of the fault detection protocol session at the first router;
determining, by the second router, unavailability of a data communication connection between the first router and a first provider edge router based on the down status; and
responding, by the second router, to the down status of the fault detection protocol session by rerouting traffic served by the first provider edge router to a second provider edge router.

2. The method of claim 1, wherein the fault detection protocol is a bidirectional forwarding detection protocol.

3. The method of claim 1, further comprising monitoring a second data communication connection between the second router and the second provider edge router with one or more sensors of the second router.

4. The method of claim 3, further comprising monitoring a Border Gateway Protocol session or other routing protocol session between the second router and the second provider edge router.

5. The method of claim 3, wherein the one or more sensors comprise a routing protocol session tracker is to perform nexthop tracking.

6. The method of claim 3, wherein the one or more sensors are to examine ARP (Address Resolution Protocol) Tables of the 2 second router and determine whether a Host/ARP entry of the second provider edge router is missing from the second router.

7. The method of claim 1, wherein the down status of the fault detection protocol session that the fault detection protocol session is down at the first router.

8. (canceled)

9. The method of claim 1, further comprising receiving, from the first router, a signal using the fault detection protocol session indicating the down status at the first router.

10. A system comprising:
a first router and a second router, the first and second routers being peers in a computing network;
a first data communication connection between the first router and a first provider edge router; and
a second data communication connection between the second router and a second provider edge router;
wherein the first router is to:
establish a fault detection protocol session with the second router;
detect, a down status of the fault detection protocol session at the second router;
determine unavailability of the second data communication connection based on the down status; and
respond to the down status of the fault detection protocol session by rerouting traffic served by the second provider edge router to the first provider edge router.

11. The system of claim 10, wherein the fault detection protocol is a bidirectional forwarding detection protocol.

12. The system of claim 10, wherein the first router comprises one or more sensors are to monitor whether the first data communication connection has gone down.

13. The system of claim 12, wherein the one or more sensors are to monitor a Border Gateway Protocol session or other routing protocol session between the first router and the first provider edge router.

14. The system of claim 12, wherein the one or more sensors comprise a routing protocol session tracker that examines ARP (Address Resolution Protocol) Tables of the first router and determines whether a Host/ARP entry of the first provider edge router is missing from the first router.

15. The system of claim 10, wherein the down status of the fault detection protocol session indicates that the fault detection protocol session is down at the second router.

16. (canceled)

17. A router comprising:
one or more sensors are to detect whether a data communication connection between the router and a first provider edge has become unavailable;
wherein the router is configured to:
respond to the one or more sensors detecting unavailability of the data communication connection by changing a status of a fault detection protocol session between the router and a peer router to a down status, which notifies the peer router that the data communication connection has become unavailable; and
sending a signal using the fault detection protocol session to the peer router, the signal indicating the down status associated with the data communication to the peer router.

18. The router as claimed in claim 17, wherein the one or more sensors are to monitor a routing protocol session between the router and the first provider edge router by examining ARP (Address Resolution Protocol) Tables of the router.

19. Computer program code that when executed by one or more processors causes the one or more processors to:
maintain, by a first router, a first data communication connection between the first router and a first provider edge router;
establish a fault detection protocol session between the first router and a second router, the first and second routers being computing network peers;
detect, by the first router, a down status of the fault detection protocol session at the second router;
determine, by the first router, unavailability of a data communication connection between the second router and a second provider edge router based on the down status; and
respond, by the first router, to the down status of the fault detection protocol session by rerouting traffic served by the second provider edge router to the first provider edge router.

20. A non-transitory computer readable medium comprising instructions to:
maintain, by a first router, a first data communication connection between the first router and a first provider edge router;
establish a fault detection protocol session between the first router and a second router, the first and second routers being computing network peers;
detect, by the first router, a down status of the fault detection protocol session at the second router;
determine, by the first router, unavailability of a second data communication connection between the second router and a second provider edge router based on the down status; and
respond, by the first router, to the down status of the fault detection protocol session by rerouting traffic served by the second provider edge router to the first provider edge router.

21. The non-transitory computer readable medium of claim 20, wherein the instructions are further to monitor the first data communication connection with one or more sensors of the first router.

22. The non-transitory computer readable medium of claim 20, wherein the instructions are further to receive, from the second router, a signal using the fault detection protocol session indicating the down status at the second router.
